(19) United States
(12) Patent Application Publication
(10) Pub. No.: US 2010/0162333 A1
(43) Pub. Date: Jun. 24, 2010

(54) READY ACCESS TO UNIFORM RESOURCE IDENTIFIERS THAT ARE ASSOCIATED WITH TELEVISION CONTENT

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/343,999

(22) Filed: Dec. 24, 2008

(51) Int. Cl. H04N 7/173

(52) U.S. Cl. 725/109

(57) ABSTRACT

The present invention provides a technique for making uniform resource identifiers (URIs) that are associated with television content that has been viewed by a viewer readily accessible to that viewer. Television content that is being viewed at any given time is monitored, and URIs that are associated with television content that has been viewed are automatically identified without human intervention and subsequently made available to the viewer via a content service. The content service may be a web server that is accessible by the viewer via a browser application running on the viewer's communication terminal. The viewer may access the content service to retrieve the URIs, which may be used to retrieve web content associated with television content from an appropriate web server via the communication terminal.

### FIELD OF THE INVENTION

The present invention relates to making uniform resource identifiers (URIs) that are associated with television content that has been viewed by a viewer readily accessible to that viewer.

### BACKGROUND OF THE INVENTION

Television content providers are increasing their efforts to tie television programming with Internet content to drive interest in the programming as well as provide additional revenue streams from web-based advertising. It is now commonplace for television programs and advertisements to include uniform resource identifiers (URIs), which point to locations on the Internet where web-based content that is associated with the programs and advertisements can be found. With the ubiquitous nature of the Internet, large numbers of viewers are now accessing the Internet to obtain the web-based content that is associated with these programs and advertisements. Unfortunately, there is no real convenient or easy way for viewers to keep track of the URIs that are presented to them while watching television, other than physically or mentally taking note of the URIs while the watching television. In addition to being inconvenient and distracting, such note taking is error prone.

Attempts have been made to automate the capture and use of URIs that are provided in association with television content. These attempts generally require customer premise equipment (CPE), such as set-top boxes or personal video recorders (PVRs), to detect specific user input when a URI of interest is presented with the television content and store the URI in response to detecting the specific user input. The CPE may provide a browser, which allows the viewer to effectively access the Internet and obtain web content associated with the URI over the Internet via the CPE. However, a vast majority of current CPEs do not have such capability and providing such capability in the future is faced with significant technological or commercial hurdles. Even when CPEs have such capability, the user interface provided by a remote control or the typical CPE control panel is extremely limited compared to a full keyboard and mouse that is normally associated with a personal computer or Internet capable mobile terminal, which is used to surf the Internet. Further, the resolution of most television monitors and the viewing distances associated with these television monitors make viewing web content difficult, and at best, much less acceptable than that provided by a personal computer or specially configured mobile terminal. Given their limited availability and practicality, existing solutions are not widely adopted and will likely not be adopted in the future.

Accordingly, there is a need for a technique to make URIs that are associated with television content readily accessible to a viewer. Given the amount of programming that includes or is otherwise associated with URIs, there is further need for a technique for making URIs that are associated with television content that has actually been viewed by a viewer readily accessible to that viewer. There is a further need to make the URIs readily accessible on a device other than the CPE via which the television content was viewed.

### SUMMARY OF THE INVENTION

The present invention provides a technique for making uniform resource identifiers (URIs) that are associated with television content that has been viewed by a viewer readily accessible to that viewer. Television content that is being viewed at any given time is monitored, and URIs that are associated with television content that has been viewed are automatically identified without human intervention and subsequently made available to the viewer via a content service. The content service may be a web server that is accessible by the viewer via a browser application running on the viewer's communication terminal. The viewer may access the content service to retrieve the URIs, which may be used to retrieve web content associated with television content from an appropriate web server via the communication terminal. The television content may be presented to the viewer for viewing via customer premise equipment (CPE), such as a set-top box, which may play a role in identifying the URIs that are associated with the television content that has been viewed.

In a first embodiment, the television content that is viewed by at least one viewer at a given location is monitored, perhaps by the CPE of the at least one viewer. A viewing history of the television content that has been viewed by the viewer is generated and provided to a content service, which will obtain the URIs that are associated with the television content of the viewing history and make the URIs available to the viewer. The viewer may access the content service and retrieve the URIs that are associated with the television content of the viewing history. Once retrieved, the viewer may use the URIs to access web content associated with the URIs.

In another embodiment, the URIs that are embedded in television content or signal carrying television content that is viewed by at least one viewer at a given location are identified and stored in a URI log, perhaps by the CPE of the at least one viewer. The URI log is provided to the content service, which will make the URIs of the URI log available to the viewer. The viewer may access the content service and retrieve the URIs that were provided with the television content that was viewed by the at least one viewer. Once retrieved, the viewer may use the URIs of the URI log to access web content associated with the URIs.

The URIs that are identified and made available by the content service may be particular to a single viewer or associated with a group of viewers. If the television content being viewed by a particular viewer is ascertainable, the URIs that are automatically identified based on the television content being viewed may be associated with that particular viewer. As such, a given viewer may access URIs that are associated with the television content viewed by that given user. The CPE may be able to ascertain which viewer is viewing certain television content by receiving direct or indirect input that identifies the viewer or viewers of television content from the viewer or viewers. For example, the viewer may directly identify themselves before or while viewing the television content, or different viewers may use different remote controls, which are distinguishable and assigned to a particular viewer. The CPE can derive who is viewing television content based on the remote control usage.

The television content that is being viewed may include live or recorded content. Live content is television content that is presented for viewing in real-time by the CPE upon being received from the content provider. Recorded content is content that has been recorded in digital video recorder, personal video recorder, or network video recorder under the direction of the viewer and subsequently played back such that the television content is subsequently presented to the viewer according to known time-shifting techniques.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIGS. 2A and 2B provide a communication flow according to one embodiment of the present invention.

FIG. 3 illustrates an exemplary web page providing a viewing history according to one embodiment of the present invention.

FIG. 4 illustrates an exemplary web page providing a URI listing for a program according to one embodiment of the present invention.

FIG. 5 illustrates an exemplary web page providing a URI listing for advertising according to one embodiment of the present invention.

FIGS. 6A through 6C provide a communication flow according to a second embodiment of the present invention.

FIG. 7 is a block representation of customer premise equipment according to one embodiment of the present invention.

FIG. 8 is a block representation of an internet content server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a technique for making uniform resource identifiers (URIs) that are associated with television content that has been viewed by a viewer readily accessible to that viewer. The URIs are generally web addresses that point to the location of web content, which has been associated with the television content in some desired fashion. Television content that is being viewed at any given time is monitored, and URIs that are associated with television content that has been viewed are automatically identified without human intervention and are subsequently made available to the viewer through an accessible content service. The viewer may later access the content service to retrieve the URIs, which may be used to retrieve the web content that is associated with television content from an appropriate web server via the Internet or like network. Prior to delving into the details of the present invention, an overview of a communication network in which the present invention may be employed is provided.

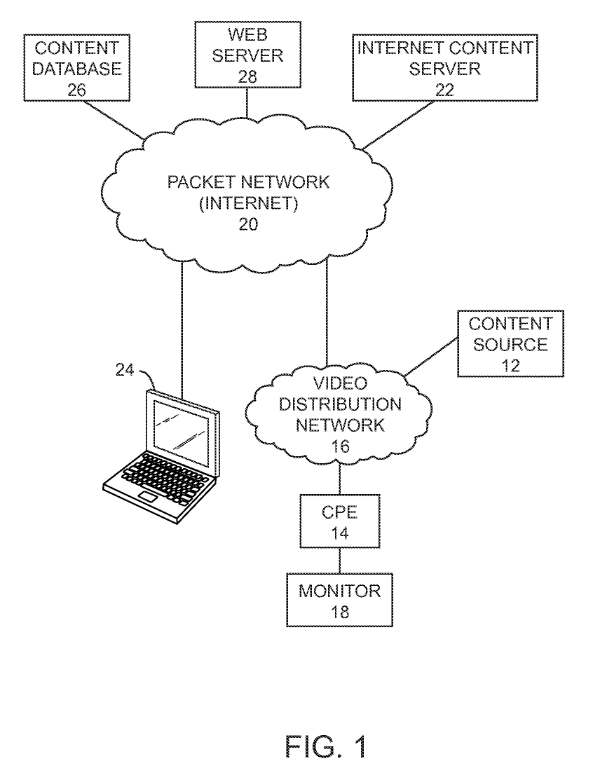

With reference to FIG. 1, a communication environment 10 is provided wherein a content source 12 is capable of delivering television content to customer premise equipment (CPE) 14, such as a personal video recorder (PVR), set-top box, cable card, or cable-ready television over an appropriate video distribution network 16. The content source 12 and the associated video distribution network 16 may be that of an over-the-air, cable, satellite, or Internet Protocol television (IPTV) television service provider, wherein the television content may be provided to the CPE 14 in real time or on demand over a single or multiple channels. The television content will typically include multiple programs that may or may not include advertising intermingled therein. As such, the television content may include program content for individual programs and advertising content for advertisements that may be provided between and dispersed within program content for the various programs.

The CPE 14 may include or be associated with equipment that provides a monitor 18 through which the television content may be viewed by one or more viewers at the customer premises. The television content, including the program content and the advertising content, may include or be associated with one or more URIs that may be of interest to the viewers. As will be described in further detail below, the present invention provides a technique for identifying the URIs that are associated with the television content that is actually viewed by the viewer or group of viewers at one or more locations, and make these URIs accessible to the viewers from a device other than the CPE 14; however, in certain embodiments of the present invention, the CPE 14 may be used to gain access to the URIs.

With the present invention, a viewing history for a viewer or group of viewers associated with the CPE 14, customer premise, or the like, is generated based on the television content that is actually presented for viewing by the CPE 14 or a group of CPEs 14. For conciseness and clarity, the following description is focused on generating viewing histories for a particular viewer; however, these concepts may be applied to a group of viewers, such as the members of a family living in a particular residence or employees of a particular business. The viewing history is effectively an historical record of the television content that was presented to the viewer for viewing over time. Since the viewer may change channels or view different programs over time, the viewing history will include sufficient information to determine the particular programs that were presented to the viewer for viewing. Accordingly, the viewing history may identify those programs that were presented to the viewer for viewing in part or in whole in a direct or indirect fashion. For example, the viewing history may identify the actual programs that were viewed in whole or in part, the program and time of viewing, or the channel and time of viewing, such that the program being viewed can be identified based on the monitored channel and time information.

The television content that is being viewed may include live or recorded content. Live content is considered to be television content that is presented for viewing in real time by the CPE 14 upon being received from the content source 12. Recorded content is considered to be television content that has been recorded by the CPE 14 or by a device associated with the CPE 14 and subsequently played back, such that the television content is subsequently presented to the viewer according to known time-shifting techniques. For recorded content, the viewing history may identify the particular program or the original channel and time at which the program was originally provided by the content source 12. Regardless of how the viewing history is created, the viewing history will include an historical record of the actual television content that was presented for viewing. The viewing history will identify or include sufficient information to identify any programs that were watched, in whole or in part, by the viewer. The viewing history or information sufficient to generate the viewing history may be generated by the CPE 14 or associated equipment of the video distribution network 16, and provided via a packet network 20, such as the Internet, to an internet content server 22.

As indicated above, the programs of the viewing history for a viewer may be associated with URIs, which point to web content that is associated in some way with the programs. Similarly, the viewing history may identify advertisements that were presented to the viewer for viewing. These advertisements may be associated with URIs in the same manner in which URIs are associated with the programs. In instances where the advertisements are not separately identified from the programs, links that are associated with particular advertisements may be combined with the URIs that are associated with the programs with which the advertisements were associated. Accordingly, the advertisements may be treated like individual programs or may be considered a part of an associated program.

In one embodiment, the television content that is presented to the viewer for viewing is monitored, perhaps by the CPE 14 or appropriate service node. A viewing history of the television content that is presented to the viewer for viewing is generated by the CPE 14. In a different embodiment, the viewing history could be captured in a service node (not shown), which is located in the video distribution network 16, where the service node can keep track of what television content is being consumed and provided to the internet content sever 22. The internet content server 22 may obtain the URIs that are associated with the different programs, and perhaps advertisements, represented by the television content of the viewing history from a content database 26, which maintains a record of the URIs that are associated with a particular program, advertisement, or channel and time combination. Once the URIs are identified, they are made available to the viewer through the internet content server 22. The viewer may access the internet content server 22 from an appropriate communication terminal 24, such as a personal computer, personal digital assistant, mobile telephone, or the like, and retrieve the URIs that are associated with the television content of the viewing history. Once retrieved, the viewer may use the URIs to access web content associated with the URIs from any number of web servers 28.

Preferably, the communication terminal 24 provides a browser that is readily capable of interacting with the internet content server 22 and the web servers via the packet network 20 in traditional fashion. Accordingly, a web page request, such as a Hypertext Transfer Protocol (HTTP) GET request, is generated and sent to the internet content server 22 from the communication terminal 24. The request may provide sufficient information to identify the viewer and perhaps a select portion of the viewing history. Upon receipt of the web page request, the internet content server 22 will generate a first web page that includes the URIs for all or the select portion of the viewing history, and if desired, all or the select portion of the viewing history. The internet content server 22 will then provide the first web page to the communication terminal 24, which will display the first web page to the viewer via the browser. In response to the viewer selecting a particular URI from the first web page, the communication terminal 24 will generate and send a web page request directed to the web server 28 that is associated with the selected URI. Upon receipt of the web page request, the web server 28 will generate a second web page including the web content that is associated with the URI, and thus a program or advertisement in the viewing history, and provide the second web page back to the communication terminal 24, which will display the second web page to the viewer via the browser.

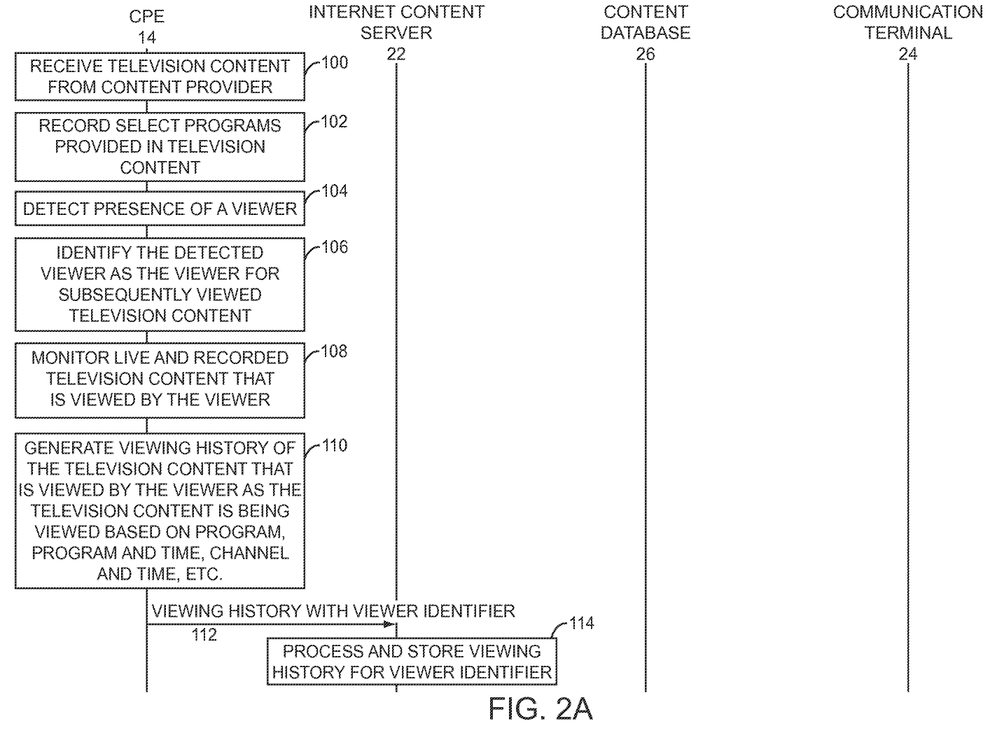

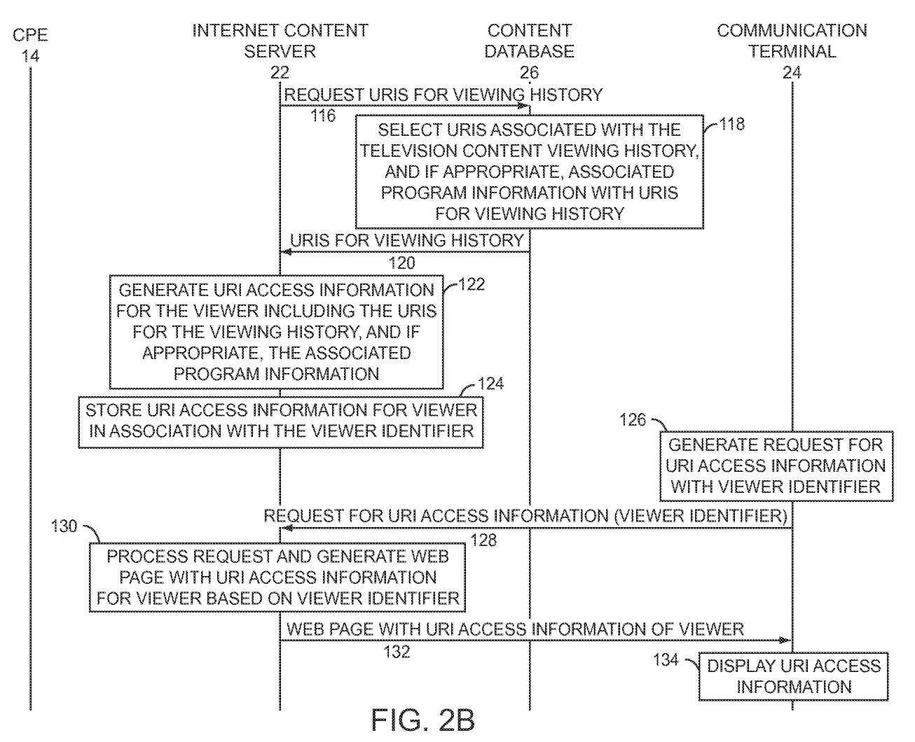

With reference to FIGS. 2A and 2B, an exemplary process is illustrated according to an embodiment wherein the URIs are identified at the internet content server 22 based on a viewing history provided by the CPE 14. Initially, the CPE 14 will receive television content from a content provider via the content source 12 and the video distribution network 16 (step 100). Based on current or prior instructions from the viewer, the CPE 14 may record select programs provided in the television content (step 102). If so equipped, the CPE 14 may be able to differentiate among any number of viewers through direct or indirect techniques. For example, upon initiating operation of the CPE 14, a viewer may be asked to identify themselves. For example, the CPE 14 may have a list of potential viewers and present this list to the viewer via the monitor 18. The viewer, through a direct interface or remote control, may provide instructions to the CPE 14 that identifies the viewer from the list. Alternatively, different viewers may use different remote controls, and based on which remote control is being used the CPE 14 may determine which viewer or viewers are interacting with the CPE 14, and thus viewing any television content being displayed. As such, the CPE 14 may keep track of different viewing histories for different viewers, and the same programs may appear on different viewing histories for the different viewers.

Accordingly, the CPE 14 may detect the presence of a viewer (step 104) and then identify the detected viewer as the viewer for subsequently viewed television content (step 106). As live and recorded television content is presented for viewing, the CPE 14 will monitor the live and recorded television content that is being viewed by the viewer (step 108) and generate an appropriate viewing history of the television content that is viewed by the viewer (step 110). The viewing history is generated as the television content is being viewed based on any information from which URIs that are associated with the particular television content may be identified. As indicated above, this information may include program information, program and time information, channel and time information, or the like. From time to time, the CPE 14 will provide the viewing history along with a viewer identifier that is associated with the viewing history to the internet content server 22 (step 112). The internet content server 22 will process and store the viewing history for the viewer identifier (step 114).

At some point, the internet content server 22 may send a request to obtain the URIs that are associated with the viewing history to the content database 26 (step 116). Based on the viewing history, the content database 26 will select the URIs that are associated with the television content identified in the viewing history (step 118). The content database 26 may include associated program or advertisement information that may be useful by the internet content server 22 in assimilating or generating web pages that include the URIs for the viewing history. For example, various text, graphics, images, or video may be associated with the URIs and may be used by the internet content server 22 when presenting the URIs to the viewer. Once selected, the URIs and the associated program or advertisement information is provided back to the internet content server 22 (step 120). Based on the URIs and any associated information, the internet content server 22 may generate URI access information for the viewer, wherein the access information includes the URIs for the viewing history, and if available, the associated program or advertisement information (step 122). The internet content server 22 will then store the URI access information for the viewer in association with the viewer identifier (step 124). Notably, the URIs for the viewing history in this example are identified prior to the viewer requesting access to the URIs. In other embodiments, the URIs may be obtained from the content database 26 based on the viewing history in a dynamic fashion in response to a request from the viewer.

Continuing with the above example, assume the internet content server 22 has access to a significant viewing history for the viewer and has obtained URIs that are associated with the television content represented in the viewing history. Further assume that the viewer has logged on to their communication terminal 24, opened a browser, and initiated an interaction with the internet content server 22. This interaction may involve sending an initial request to the internet content server 22 that will provide a logon page back to the communication terminal 24 (not shown). After logging on to the URI access service provided by the internet content server 22, the communication terminal 24 may generate a request for URI access information associated with the viewer identifier of the viewer based on information provided by the viewer (step 126). The request for the URI access information for the viewer identifier is sent to the internet content server 22 (step 128), which will process the request and generate a web page with URI access information for the viewer based on the viewer identifier (step 130). The web page with the URI access information is provided to the communication terminal 24 (step 132), which will display the URI access information to the viewer (step 134).

Although only a single interaction is illustrated, multiple interactions may take place between the internet content server 22 and the communication terminal 24 prior to the URI access information being provided to the communication terminal 24. Again, the URI access information includes all or certain URIs that were associated with television content watched by the viewer, and any supplemental information that may have been obtained from the internet content server 22 or other information service. As those skilled in the art will appreciate, the format in which the URIs may be presented to the viewer is virtually limitless, and the URIs may be presented with various other types of information alone or in association with the viewing history from which the URIs were derived. The viewing history may be provided in association with the URI access information, wherein the URIs are presented along with a representation of the viewing history. For example, the viewing history may be presented to the viewer such that the programs viewed by the viewer are presented in chronological order, and the URIs associated with each of the respective programs are displayed with the corresponding programs. As such, a viewer may quickly identify a program from which a particular URI was desired and then view the URIs associated with that particular program. Once the viewing history and the associated URIs are obtained, they may be searched, sorted, or categorized in virtually any fashion.

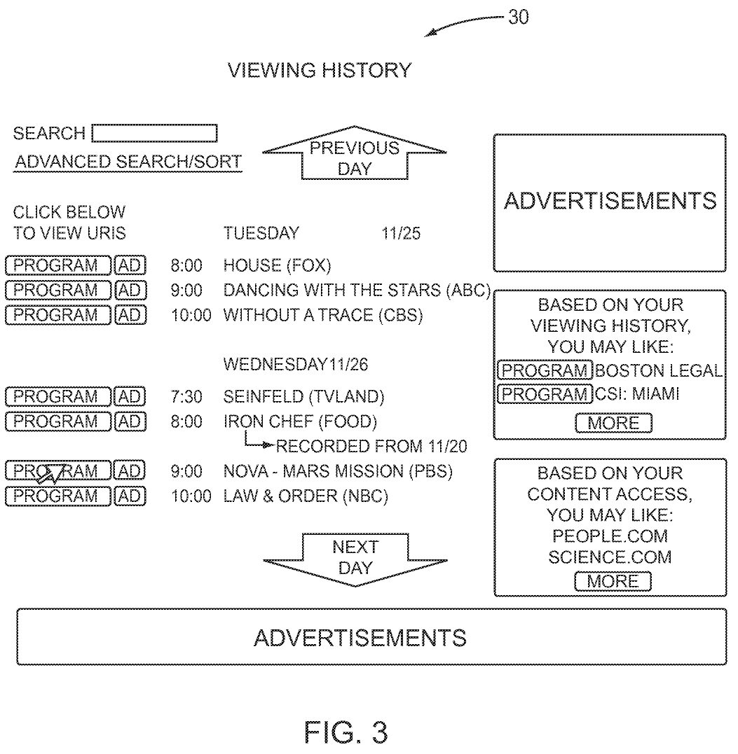

Although the viewing history and the associated URIs may be presented in a single web page, the viewing history or any select portion thereof may be provided in a first web page, which provides links to other web pages that will include the associated URIs. With reference to FIG. 3, an exemplary web page 30 is illustrated. The web page 30 represents an exemplary way to illustrate a portion of a viewing history for a viewer. As depicted, the programs that were watched in whole or in part by the viewer on Tuesday, November 25^{th} and Wednesday, November 26^{th} are identified along with the time at which the programs were actually watched. For example, on Tuesday, November 25^{th}, the viewer watched “House” on Fox at 8 pm, “Dancing with the Stars” on ABC at 9 pm, and “Without a Trace” on CBS at 10 pm. For these programs, they were live programs that were watched at their normally scheduled broadcast times. On Wednesday, November 26^{th}, the viewer watched “Seinfeld” on TV Land at 7:30 pm, and at 8 pm watched an episode of “Iron Chef” of the Food Network that was recorded from November 20^{th}. As such, the viewing history for the viewer kept track of both live and recorded television content. Continuing with the viewing history for Wednesday, November 26^{th}, the viewer watched “Nova—Mars Mission” on PBS at 9 pm and “Law & Order” on NBC at 10 pm. The web page 30 provides links to scroll through the previous and next days of the viewing history, wherein selection of the previous day would present the viewing history for Monday, November 24^{th} and selection of the next day link would present the viewing history for Thursday, November 27^{th}.

Notably, associated with each entry in the viewing history are “program” and “ad” links. Upon selection of a program link associated with a particular entry in the viewing history, the communication terminal 24 will send a request for a web page associated with that particular link to the internet content server 22. In response, the internet content server 22 will generate a web page that includes the URIs for the particular program in the viewing history. Similarly, if an ad link for a particular program is selected, the URIs associated with advertisements that were presented in association with the program are identified by the internet content server 22 and are presented in a web page to the communication terminal 24.

As illustrated in FIG. 3, numerous items of information may be provided along with the viewing history and the links for the program and ad URIs. For example, various advertisements may be presented in the web page 30 as well as links to facilitate searching of the URIs, the viewing history, or any other desired information. Additional information may include recommendations and links to additional information associated with the particular recommendations. For example, the web page 30 provides two types of recommendations. The first type is a recommendation based on the viewer's viewing history, while the other type relates to prior content accessed by the viewer through the internet content server 22. Accordingly, the internet content server 22 may analyze the viewing history and generate recommendations for programs that might be of interest to the viewer, such as “Boston Legal” and “CSI: Miami,” as well as various URIs that may be of interest to the viewer based on the viewer's viewing history. In addition to making recommendations based on the viewing history, the internet content server 22 may make recommendations for programs or URIs, such as people.com and science.com, based on any URIs that have been selected by the viewer in the past through the internet content server 22.

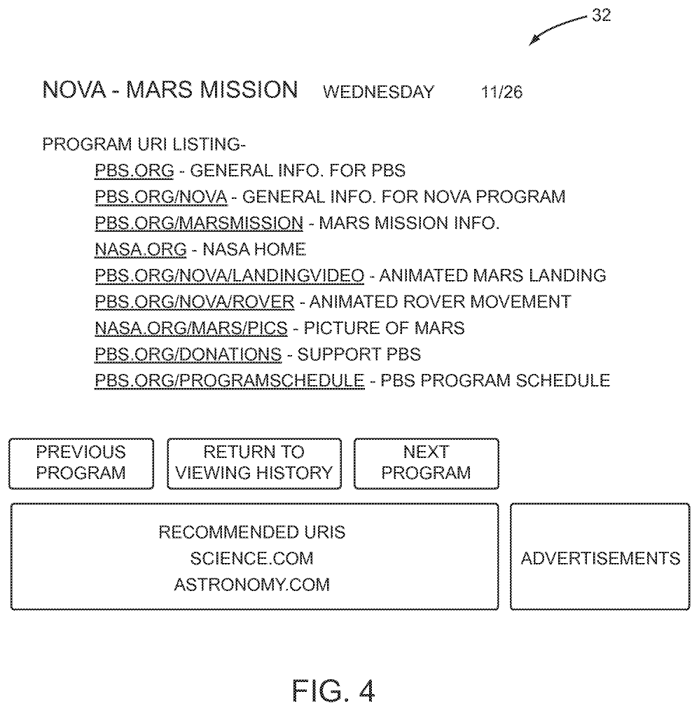

Continuing with the above example, assume the web page 30 is presented to the viewer via the communication terminal 24, and that the viewer is interested in URIs that are associated with the program “Nova—Mars Mission,” which aired in PBS at 9 pm on Wednesday, November 26^{th}. As such, the viewer may select the program link that corresponds to the program “Nova—Mars Mission,” which will trigger a request being sent to the internet content server 22 for the program URIs that are associated with the program “Nova—Mars Mission.” An exemplary web page 32 for providing the program URIs for “Nova—Mars Mission” is illustrated in FIG. 4. As depicted, numerous URIs, such as pbs.org; pbs.org/nova, pbs.org/marsmission; nasa.org; pbs.org/nova/landingvideo; and the like, are depicted with associated information. For example, pbs.org is associated with the information “general information for PBS.” This associated information may represent the associated program information that was obtained from the content database 26 when the URIs were being obtained in light of the viewing history of the viewer. Although text is illustrated, this associated program information may represent any one or a combination of text, graphics, images, video, and the like. This information is not to be confused with the web content that will be provided by an appropriate web server 28 in response to sending a request toward the URI to the appropriate web server 28. This associated program information may simply be used to help the viewer identify the URI or determine the type of information that is associated with the URI.

Preferably, the web page 32 is configured such that selecting a URI will result in a request being generated and sent toward a web server 28 that is associated with the URI. Upon receipt of the request, the web server 28 will generate a web page with the web content associated with the URI and provide the web page back to the communication terminal 24 in traditional fashion. As illustrated, the web page 32 may include links to URIs of different programs as well as a link to return to the viewing history, which is represented by the web page 30 of FIG. 3. Continuing with the web page 32 of FIG. 4, additional advertisements may be provided as well as recommendations for other URIs or programs based on various criteria. Links to these recommended programs or URIs may be provided in the web page 32 along with the recommendations.

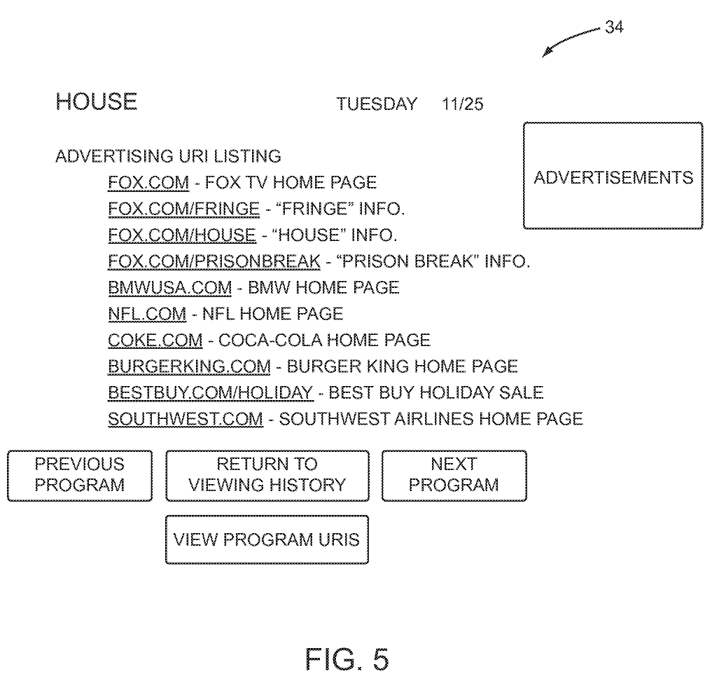

Returning to FIG. 3, and the web page 30 in particular, assume the viewer selects the “ad” link associated with the program “House” that aired on Fox at 8 pm on Tuesday, November 25^{th}. Upon selection of this “ad” link, a web page 34, as illustrated in FIG. 5, may be generated by the internet content server 22 and provided to the communication terminal 24 for presentation to the viewer. The web page 34 will include the URIs that were associated with the advertisements presented in association with the program “House.” For example, the advertising URIs may include fox.com, which is a URI associated with the Fox Broadcasting Network and points to the home page for Fox Television. Assuming that the program “House” is associated with advertisements for the Fox programs “Fringe” and “Prison Break” as well as a future episode of “House,” the URIs associated with these advertisements may include fox.com/fringe, fox.com/house, and fox.com/prisonbreak. Other advertisement that were provided in association with the program “House” may include advertisements for BMW, the National Football League (NFL), Coca-Cola, Burger King, Best Buy, and Southwest Airlines. Assuming each of these advertisements includes the primary advertising link to the home page of the associated company, the URIs in the advertising URI listing may also include URIs for bmwusa.com; nfl.com; coke.com; burgerking.com; bestbuy.com/holiday; and southwest.com.

Notably, these URIs may point to home pages or to particular sites for a given advertiser. For example, bmwusa.com may point to the home page of BMW, whereas bestbuy.com/holiday may point to a particular holiday sale web page provided by Best Buy. The information that is shown in association with the various URIs may represent the associated program or advertising information that was obtained by the internet content server 22 from the content database 26 when the URIs for the viewing history were obtained. As with the other web pages, the web page 34 may include links to various other pages as well as advertisements, recommendations, and the like. The illustrated links include links to obtain advertising URIs for a previous program and the next program; a link to return to the viewing history (web page 30 of FIG. 3); and a link to view the URIs associated with the program “House.” Accordingly, if the user selects the “view program URIs” link of the web page 34, the internet content server 22 will generate a web page that includes the program URI listing for the program “House” in a similar fashion as the program URI listing for the program “Nova—Mars Mission” as illustrated in FIG. 4.

In the above embodiment, the television content that is presented for viewing by the viewer may but need not include the URIs that are associated with the television content to be provided in a manner wherein they are actually visible when television content is being viewed. However, in a preferred embodiment, at least those URIs that form part of the television content that is presented to the viewer are retrieved by the internet content server 22 as described above based on the viewing history. With the above embodiment, the CPE 14 need only keep track of the viewing history and report the viewing history to the internet content server 22, which will access the associated URIs and make them available to the viewer via the communication terminal 24, or perhaps the CPE 14. The CPE 14 need not have the ability to actually recognize or otherwise detect URIs that are embedded in the actual television content or provided in the transport signal or stream that is used to carry the television content from the content source 12 to the CPE 14.

In another embodiment of the present invention, the television content will include URIs, wherein the signals and streams associated with the television content will include URIs. For example, the vertical blanking interval in over-the-air, cable, and satellite television signals is often used to carry closed captioning information. URI information may be provided in the vertical blanking interval and detected and extracted by the CPE 14. Whether embedded in the television content or provided in the signal stream that carries the television content, the CPE 14 may be configured to extract URIs from the television content or the transport signal stream that carries the television content, and generate a log containing the extracted URIs. This log of URIs is generally referred to as a URI log. As such, once the CPE 14 has extracted the URI information it may be provided in the URI log. Those skilled in the art will recognize other techniques for delivering URIs or information including URIs within or in association with television content and configuring the CPE 14 to monitor such information and detect the presence of URIs that are associated with the television content. As in the above embodiment, the CPE 14 is able to identify the television content that is being presented to the viewer for viewing, and will store the URIs that are associated with the television content that is being viewed in the URI log. From time to time, newly extracted URIs or the URI log itself may be uploaded to the internet content server 22 alone or in association with the viewing history. Notably, a viewing history does not need to be maintained for this embodiment; however, maintaining a viewing history and uploading it to the internet content server 22 with the URI log will generally allow the internet content server 22 to provide a more enhanced interface for the viewer when the viewer subsequently accesses the URIs.

If the viewing history is not available, the viewer may access the internet content server 22 through the communication terminal 24 to gain access to the URIs associated with the television content that has been or is being watched. Upon identifying the URI log associated with the viewer, the internet content server 22 may generate a web page that lists certain or all of the available URIs that were provided in the URI log and send the web page to the communication terminal 24 for presentation to the viewer. In generating the web page, the internet content server 22 may access the content database 26 to identify basic information associated with the URIs and use the information when generating the web page that includes the URIs. If the viewing information is available, the URIs may be presented in association with the programs to which they correspond. For example, a viewer's viewing history may be presented in a web page, such as the web page 30 of FIG. 3, wherein links are provided to allow the viewer to access one or more URIs that are associated with a selected program or advertisement, as illustrated in the web pages 32 and 34 of FIGS. 4 and 5. The differences in the two embodiments described above relate to how the URIs are actually identified based on the television content being viewed by the viewer. Once the URI information is available, and perhaps the associated viewing history, the URIs, viewing history, and like information may be generated and provided to the viewer in any desired fashion.

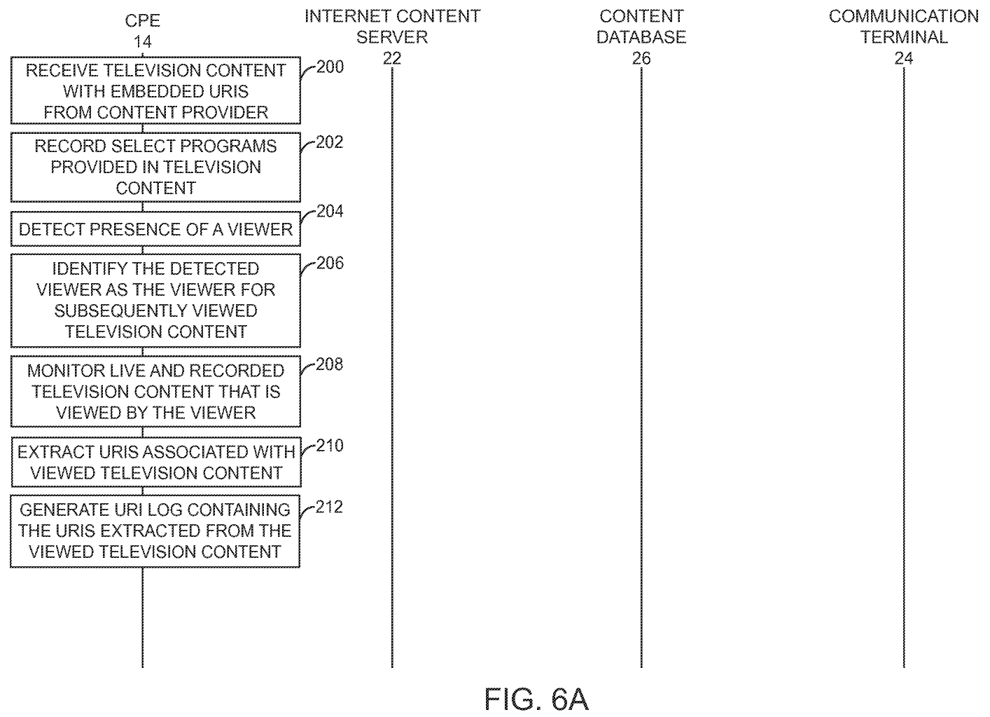

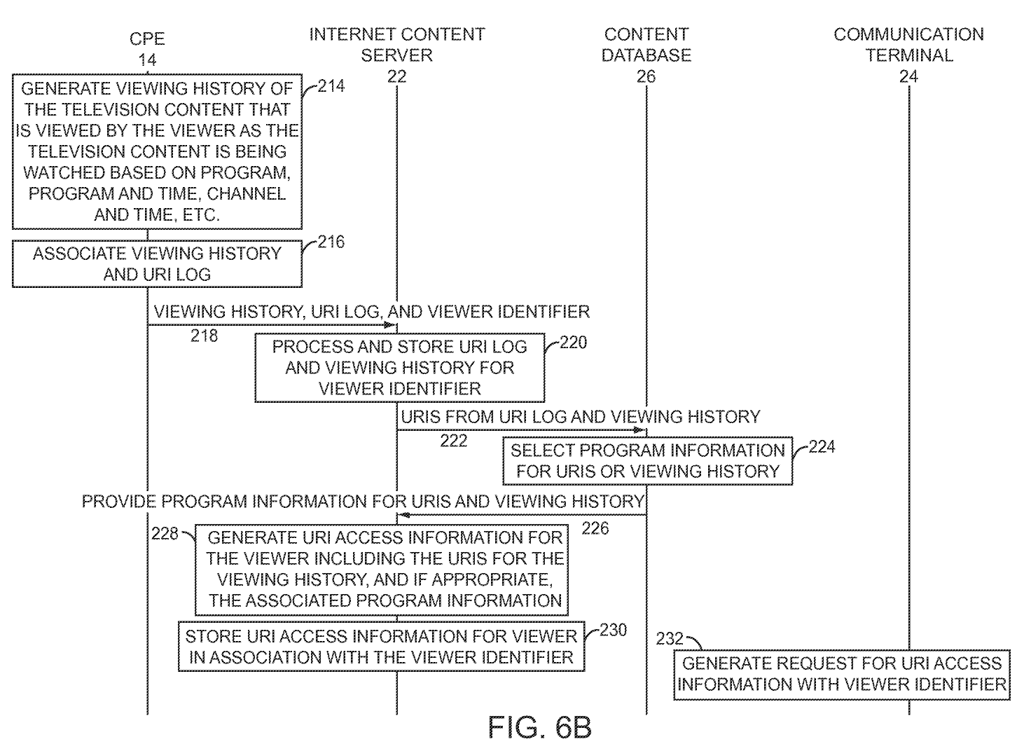

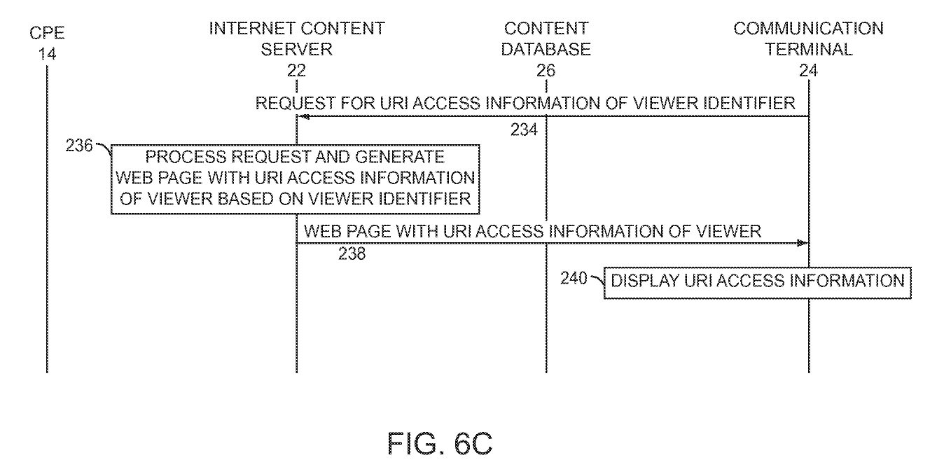

With reference to FIGS. 6A through 6C, a communication flow is provided to illustrate the detection of URIs at the CPE 14 and having the CPE 14 provide URIs or a URI log to the internet content server 22 in association with a viewing history. Initially, assume television content is being received with URIs either embedded in the television content or embedded in the transport stream or signal that carried the television content (step 200). The CPE 14 will record selected programs provided in the television content based on preconfigured settings or instructions from the viewer (step 202). As with the above embodiment, the CPE 14 may be able to detect the presence of the viewer (step 204) as well as identify the particular viewer as the viewer for subsequently viewed television content, whether it is live content or previously recorded content that is stored locally or on another storage device (step 206).

The CPE 14 will monitor the live and recorded television content that is viewed by the viewer (step 208) and extract any URIs associated with the television content being viewed (step 210). The CPE 14 will generate a URI log containing the URIs that are extracted from the television content that has been viewed (step 212), and perhaps generate a viewing history of the television content that is viewed by the viewer (step 214). As described above, the viewing history may be based on programs being watched, the program and times that the television content is being viewed, the channel and times at which television content is being viewed, and the like. If the viewing history is maintained and is going to be provided to the internet content server 22, the CPE 14 may associate the viewing history and the URI log (step 216) and send the viewing history and the associated URI log, preferably with a viewer identifier, to the internet content server 22 (step 218). The internet content server 22 will process and store the URI log and viewing history in association with the viewer identifier (step 220). The internet content server may send the URIs from the URI log, and perhaps the viewing history, to the content database 26, which may select supplemental program or advertisement information that is associated with the URIs or the viewing history (step 224). Any supplemental program or advertisement information for the URIs in the viewing history are provided back to the internet content server 22 (step 226). The internet content server 22 may then generate URI access information for the viewer including the URIs for the viewing history, and if appropriate any associated program or advertisement information (step 228) and store the URI access information for the viewer in association with the viewer identifier (step 230).

When the viewer wants to access the URIs that are associated with television content that has been viewed or the viewing history in general, they may access the internet content server 22 via the communication terminal 24. At some point during the interaction, the communication terminal 24 may generate a request for the URI access information for the viewer identifier of the viewer (step 232) and send the request to the internet content server 22 (step 234). The internet content server 22 may process the request and generate a web page with the URI access information of the viewer based on the viewer identifier (step 236) and provide the web page with the URI access information to the communication terminal 24 (step 238). Upon receipt, the communication terminal 24 may display the URI access information to the viewer (step 240).

With either of the above embodiments, the CPE 14 may be configured to apply one or more rules when generating a viewing history or otherwise considering whether television content is being viewed by the viewer. For example, viewers may surf from one channel to the next without staying on a given channel or program for any significant amount of time. As such, the television content that is identified for the viewing history or the URIs that are extracted from television content that is actually being presented to the viewer are only considered for the viewing history or URI log, respectively, when a given program or channel is being presented to the viewer for more than a minimum amount of time, such as a minute or ten minutes. As such, limited viewing of a particular program or channel will not result in the corresponding television content being provided in the viewing history or any associated URIs being provided in the URI log. Further, the viewing history and URI logs may be maintained indefinitely or for a defined amount of time, such as one week, six months, or the like. The length of the viewing history or URI log may be based on the amount of memory available for storing such information or a certain amount of content. These rules may be applied at the CPE 14 or at the internet content server 22. Similarly, the viewing history and URI logs may be partially or totally cleared at the CPE 14 or at the internet content server 22 based on input from the viewer via the CPE 14 or the communication terminal 24.

The programs in the viewing history or the associated URIs may be presented to the viewer by the internet content server 22 in a variety of ways, as indicated above. As an alternative to associating the program or advertisement URIs with their associated programs, the URIs for the programs, advertisements, or a combination thereof may be provided in a chronological order, an alphabetical order, in content-based categories, program-based categories, or the like. Further, URIs may be filtered in or out of the list to be presented based on any available criteria. For example, when the URIs of a program and its advertisements are provided or otherwise made available to the viewer, the URI list may be filtered such that only URIs associated with the program content are provided, only URIs associated with the advertising content are provided, only program and advertisement URIs associated with a given program are provided, and the like. In addition to filtering, the programs, channels, times, and advertisements provided in the viewing history as well as the associated URIs may be searched based on keywords, program type, advertisement type, channels, time periods, and the like.

Further, the information associated with the viewing history or the corresponding URIs may be presented in any format, and should not be limited to the examples provided above. For example, the viewing history may be presented in a calendar style, wherein selection of a specific time slot or program triggers the presentation of URIs associated with that particular time slot or program.

Preferably, the internet content server 22 is configured to keep track of the URIs that are selected by the viewer. Tracking the URIs that are selected by the viewer may be used to provide recommendations related to other web content or programming. If the actions of multiple viewers in different locations are tracked, recommendations may be generated based on the group or sub-groups thereof, wherein a service provider may be able to monitor the various actions of the viewers and provide recommendations for viewers that have certain similarities in viewing history or URI selections. The viewer actions may be used to provide advertising in association with presentation of the viewing histories and URIs. Further, the internet content server 22 may track the user of advertising-related URIs by the various viewers to aid in targeted advertising, determining the relative success rate for advertisements provided in the television content, and the like. Viewers may be encouraged to access advertising-based URIs by providing those viewers who access URIs with credits for additional services, rate reductions, reduction in advertising content provided in the television content, and the like. Selection of these URIs may also be used to generate revenue for the service providers or television broadcasters, wherein a viewer selecting an advertising-based URI will result in a fee being charged to the advertiser.

As those skilled in the art will appreciate, the present invention provides tremendous flexibility in dynamically and automatically identifying URIs that are associated with television content that is actually being viewed by a viewer, and then allowing the viewer to subsequently access the URIs via the Internet. Since most web-based content is more readily accessible via a browser-based communication terminal 24, the URIs that are identified in association with the television content that is actually used by the viewer are accessible through a browser of the communication terminal 24.

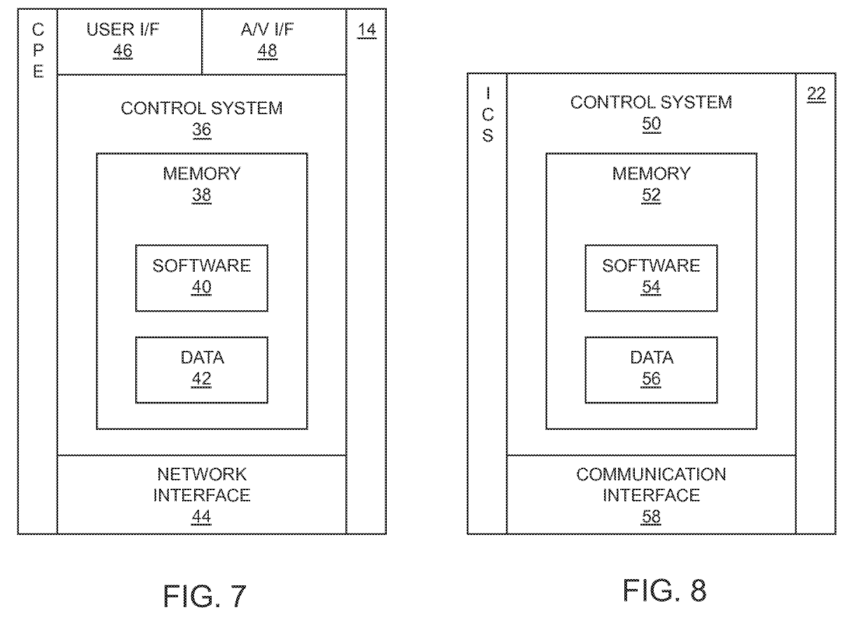

With reference to FIG. 7, a block representation of a CPE 14 is illustrated according to one embodiment of the present invention. In particular, the CPE 14 will include a control system 36 having sufficient memory 38 for the requisite software 40 and data 42 to operate as described above. The control system 36 may also be associated with a network interface 44, a user interface (I/F) 46, and an audio/video (A/V) interface 48. The network interface 44 allows the CPE 14 to communicate over the video distribution network 16 and the packet network 20 to facilitate reception of television content from the content source 12 as well as interaction with the internet content server 22, and any other entities associated with either network. The user interface 46 may include a keypad and display, as well as a remote control interface to facilitate interaction with one or more viewers. The audio/video interface 48 may include the requisite audio and video processing circuitry to facilitate interaction with an associated audio system and the monitor 18. In certain embodiments, the CPE 14 may incorporate an audio system including speakers, as well as the monitor 18. In other embodiments, the CPE 14 may represent a set-top box or PVR. Further, the functionality of the CPE 14 may be provided in a cable card or built into an appropriately configured television or the like.

With reference to FIG. 8, the internet content server (ICS) 22 may include a control system 50 having sufficient memory 52 for the requisite software 54 and data 56 to operate as described above. The control system 50 may be associated with a communication interface 58 to facilitate communications over the packet network 20 with the CPE 14, web server 28, content database 26, communication terminal 24, and the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
automatically obtaining uniform resource identifiers (URIs) that point to web content and are associated with television content that has been presented to a viewer for viewing via customer premise equipment, wherein the URIs that are obtained are identified URIs;
receiving a request from a user terminal other than the customer premise equipment; and
in response to the request, providing a response including at least one of the URIs to the user terminal, wherein the user terminal presents the at least one of the URIs to the viewer as one or more of the URIs that were associated with the television content that has been viewed by the viewer.

2. The method of claim 1 wherein the request is a web-based request from a browser running on the user terminal and the response is a web page that comprises the at least one of the URIs.

3. The method of claim 1 wherein the television content that has been presented to the viewer for viewing comprises both recorded television content and live television content, one or more of the URIs are associated with the live television content, and one or more of the URIs are associated with the recorded television content.

4. The method of claim 3 wherein the at least one of the URIs comprises at least one live content URI that is associated with the live television content and at least one recorded content URI that is associated with the recorded television content, and wherein the response includes first information that identifies the at least one recorded content URI as being associated with the recorded content.

5. The method of claim 1 wherein the television content that has been presented to the viewer for viewing comprises both program content and advertising content, one or more of the URIs are associated with the program content, and one or more of the URIs are associated with the advertising content.

6. The method of claim 5 wherein the at least one of the URIs comprises at least one advertising URI that is associated with the advertising content and at least one program URI that is associated with the program content, and wherein the response includes at least one of first information that identifies the at least one program URI as being associated with the program content and second information that identifies the at least one advertising URI as being associated with the advertising content.

7. The method of claim 1 wherein the television content comprises a plurality of programs that have been presented to the viewer at least in part via the customer premise equipment and at least two of the plurality of programs are associated with different ones of the URIs.

8. The method of claim 7 wherein different ones of the plurality of programs are provided over different channels.

9. The method of claim 1 further comprising obtaining a viewing history corresponding to the television content that has been presented to the viewer for viewing wherein the television content comprises content for a plurality of programs from different channels that has been presented to the viewer and the viewing history provides a record of the television content that has been presented to the viewer for viewing.

10. The method of claim 9 wherein the viewing history identifies the plurality of programs that have been presented to the viewer.

11. The method of claim 9 wherein the viewing history identifies a channel and time associated with the plurality of programs that have been presented to the viewer.

12. The method of claim 9 wherein the viewing history is obtained from the customer premise equipment.

13. The method of claim 9 further comprising providing at least a portion of the viewing history to the user terminal.

14. The method of claim 13 wherein the at least a portion of the viewing history corresponds to the at least one URI.

15. The method of claim 9 wherein obtaining the URIs comprises identifying the URIs based on the viewing history.

16. The method of claim 15 wherein the viewing history is received from the customer premise equipment and the URIs are not provided by the customer premise equipment.

17. The method of claim 15 wherein identifying the URIs comprises sending the viewing history to a content server and receiving the URIs for the viewing history from the content server.

18. The method of claim 15 wherein the at least one of the URIs and the viewing history are provided to the user terminal in one or more web pages.

19. The method of claim 1 wherein obtaining the URIs comprises receiving the URIs from the customer premise equipment.

20. The method of claim 19 wherein the customer premise equipment identifies the URIs, which are provided as part of the television content that has been presented to the viewer for viewing.

21. The method of claim 19 wherein the customer premise equipment identifies the URIs, which are provided along with the television content that has been presented to the viewer for viewing.

22. The method of claim 19 wherein the customer premise equipment identifies the URIs, which are provided in a vertical blanking interval of a television signal that transports the television content that has been presented to the viewer for viewing.

23. The method of claim 19 wherein the at least one of the URIs and a viewing history are provided to the user terminal in one or more web pages, the viewing history corresponding to the television content that has been presented to the viewer for viewing, and wherein the television content comprises content for a plurality of programs from different channels that has been presented to the viewer and the viewing history provides a record of the television content that has been presented to the viewer for viewing.

24. The method of claim 1 further comprising providing recommendations for web content or program content to the viewer in association with the at least one of the URIs based on the URIs or the television content.

25. The method of claim 1 further comprising providing advertisements to the viewer in association with the at least one of the URIs based on the URIs or the television content.

26. The method of claim 1 further comprising identifying the viewer as a particular viewer associated with the television content.

27. The method of claim 26 wherein the customer premise equipment identifies the particular viewer and associates the particular viewer with the television content, and identifying the viewer as the particular viewer comprises receiving information associating the television content that has been presented to the viewer for viewing with the particular viewer.

28. A system comprising:
at least one communication interface; and
a control system associated with the at least one communication interface and adapted to:
automatically obtain uniform resource identifiers (URIs) that point to web content and are associated with television content that has been presented to a viewer for viewing via customer premise equipment, wherein the URIs that are obtained are identified URIs;
receive a request from a user terminal other than the customer premise equipment; and
in response to the request, provide a response including at least one of the URIs to the user terminal, wherein the user terminal presents the at least one of the URIs to the viewer as one or more of the URIs that were associated with the television content that has been viewed by the viewer.

29. The system of claim 28 wherein the request is a web-based request from a browser running on the user terminal and the response is a web page that comprises the at least one of the URIs.

30. The system of claim 29 further comprising obtaining a viewing history corresponding to the television content that has been presented to the viewer for viewing, wherein the television content comprises content for a plurality of programs from different channels that has been presented to the viewer, the viewing history provides a record of the television content that has been presented to the viewer for viewing, and wherein obtaining the URIs comprises identifying the URIs based on the viewing history.

31. The system of claim 28 wherein obtaining the URIs comprises receiving the URIs from the customer premise equipment.
